(19) United States
(12) Patent Application Publication
(10) Pub. No.: US 2006/0294566 A1
(43) Pub. Date: Dec. 28, 2006

(54) Method and apparatus for automatically altering viewed segments of television broadcast

(76) Inventor: Wayne Zlattner, Natania (IL)

Correspondence Address: Martin D. Moynihan;PRSTI, Inc., P.O. Box 16446, Arlington, VA, 22215, US

(21) Appl. No.: 10/571,762

(22) PCT Filed:
(86) PCT No.: PCT/IL04/00803

Related U.S. Application Data
(60) Provisional application No. 60/503,634, filed on Sep. 17, 2003.

(51) Int. Cl. H04N 7/173; H04N 7/16

(52) U.S. Cl. 725/112; 725/110; 725/113; 725/62

(57) ABSTRACT

A system and method for identifying real time changes in broadcasted segments, communicating the changes over the Internet to a user PC (130) and performing pre-defined operation in response to the identified changes, including switching to another channel, changing the volume of the current channel, using IR/RF transceivers (140, 150).

### CROSS-REFERENCE TO RELATED PATENT APPLICATIONS

This patent application claims priority from and is related to U.S. Provisional Patent Application Ser. No. 60/503,634, filed Sep. 17, 2003, this U.S. Provisional Patent Application incorporated by reference in its entirety herein.

### FIELD OF THE INVENTION

The invention pertains to the field of television broadcasts and primarily to avoiding undesired segments of television broadcasts.

### BACKGROUND OF THE INVENTION

For many Television viewers, commercial interruption during a viewed program are nuisance. Often, this interference is further compounded by a higher volume setting during the broadcast of commercials, often bordering on the intolerable. Often, one is also subjected to sudden changes in content, such as sexual content not suitable for viewing by youngsters. In another scenario, TV viewers sometimes wish to be alerted in real-time when a special event of interest is being broadcast, such as a special news flash or sports event.

U.S. Pat. Nos. 6,597,405 and 6,771,316 to Iggulden, disclose a method and apparatus for identifying selected broadcast segments, such as commercial advertisements, of a television signal in real-time for the purpose of muting the video and audio portions of the television signal during each unwanted segment. A signature pattern associated with each segment of the television signal is detected and compared to stored signature patterns representative of selected segments such as commercial advertisement segments. If the signature pattern matches one of the stored signature patterns, the segment is thereby immediately identified as being one of the selected segments and is processed in real-time to mute the audio and video portions of the television signal during the segment.

U.S. Pat. No. 6,757,912 to Vaughan, et al. discloses a system for dynamically defining individual channel behavior from a variety of tuner sources within an integrated PC/TV apparatus. The system enables a user to dynamically access and alter the channel parameters and data to tailor channel behavior to a user's personal preferences.

There is need for a functionality that will give a TV viewer the ability to switch to and from another channel of preference upon the occurrence of a pre-defined event such as commercial broadcasting in the currently watched channels, or to pre-define a broadcasted event, or type of events, to take precedence and be switched-to whenever a broadcast thereof is starting.

### SUMMARY OF THE INVENTION

According to a first aspect of present invention there is provided a system for reporting selective changes in TV broadcasting content, comprising: TV analysis means for detecting and reporting changes in TV broadcasted content for a plurality of channel; and a Web Server in communication with the TV analysis means, for receiving the reported changes and for transmitting them to at least one subscriber, the Web Server storing a database of the plurality of channels and their current status; wherein the transmitting comprises selectively transmitting a full status report for all the plurality of channels or a partial status report for a selected number of channels.

In a first embodiment, the TV analysis means is automatic.

In a second embodiment, the Web Server transmits a full status report to the at least one subscriber upon the subscriber connecting to the system.

According to a second aspect of the present invention there is provided a system for selectively changing viewed TV segments, comprising: TV analysis means for detecting and communicating changes in TV broadcasted content for a plurality of channels; a computer storing a database of desired selective changes in viewed TV segments, the computer in communication with the TV analysis means; a first IR/RF transceiver in communication with the computer; and a second IR/RF transceiver in communication with the first IR/RF transceiver and with at least one media device, wherein the first and second IR/RF transceivers are operable to communicate from the computer to the at least one media device control signals for implementing the desired selective changes.

In a first embodiment, the TV analysis means is automatic.

In a second embodiment, the at least one media device is selected from the group comprising: cable decoder, satellite decoder, TV set, VCR, DVD player and receiver.

In a third embodiment, the selective changes are selected from a group comprising: switching to a different channel and changing the volume.

In a fourth embodiment, the database additionally comprises information about desired action following the selective change.

In a fifth embodiment, the desired action is selected from the group comprising: switching back to the original channel, switching to a different channel and changing the volume.

In a sixth embodiment, the first IR/RF transceiver is operable to receive IR signals from the computer, convert the IR signals to RF signals and transmit the RF signals to the second IR/RF transceiver.

In a seventh embodiment, the second IR/RF transceiver is operable to receive RF signals from the first IR/RF transceiver, convert them to IR signals and transmit the IR signals to the at least one media device.

In an eighth embodiment, the system additionally comprises a hand held remote control device, operable to transmit to the second IR/RF transceiver IR signals denoting change of viewed channel.

In a ninth embodiment, the second IR/RF transceiver is operable to convert the IR signals to RF signals and transmit the RF signals to the first IR/RF transceiver.

In a tenth embodiment, the first IR/RF transceiver is operable to convert the RF signals to IR signals and communicate the IR signals to the computer for synchronization.

According to a third aspect of the present invention there is provided a system for selectively changing viewed TV segments, comprising: TV analysis means for detecting and reporting changes in TV broadcasted content for a plurality of channels; a Web Server in communication with the TV analysis means, for receiving the reported changes and for transmitting them to at least one subscriber, the Web Server storing a database of the plurality of channels and their current status; at least one subscriber computer storing a database of desired selective changes in viewed TV segments, the computer in communication with the Web Server; a first IR/RF transceiver in communication with the computer; and a second IR/RF transceiver in communication with the first IR/RF transceiver and with at least one media device, wherein the first and second IR/RF transceivers are operable to communicate from the computer to the at least one media device control signals for implementing the desired selective changes.

In a first embodiment, the TV analysis means is automatic.

In a second embodiment, the Web Server transmits a full status report to the at least one subscriber upon the subscriber connecting to the system.

In a third embodiment, the at least one media device is selected from the group comprising: cable decoder, satellite decoder, TV set, VCR, DVD player and receiver.

In a fourth embodiment, the selective changes are selected from the group comprising: switching to a different channel and changing the volume.

In a fifth embodiment, the database additionally comprises information about desired action following the selective change.

In a sixth embodiment, the desired action is selected from the group comprising: switching back to the original channel, switching to a different channel and changing the volume.

In a seventh embodiment, the first IR/RF transceiver is operable to receive IR signals from the computer, convert the IR signals to RF signals and transmit the RF signals to the second IR/RF transceiver.

In an eighth embodiment, the second IR/RF transceiver is operable to receive RF signals from the first IR/RF transceiver, convert them to IR signals and transmit the IR signals to the at least one media device.

In a ninth embodiment, the system additionally comprises a hand held remote control device operable to transmit to the second IR/RF transceiver IR signals denoting change of viewed channel.

In a tenth embodiment, the second IR/RF transceiver is operable to convert the IR signals to RF signals and transmit the RF signals to the first IR/RF transceiver.

In an eleventh embodiment, the first IR/RF transceiver is operable to convert the RF signals to IR signals and communicate the IR signals to the computer for synchronization.

According to a fourth aspect of the present invention there is provided a method of reporting selective changes in TV broadcasting content, comprising the steps of: detecting changes in TV broadcasted content for a plurality of channels; and reporting the detected changes to at least one subscriber; wherein the reporting comprises selectively transmitting a full status report for all the plurality of channels or a partial status report for a selected number of channels.

In a first embodiment, the detecting is automatic.

According to a fifth aspect of the present invention there is provided a method of selectively changing viewed TV segments, comprising the steps of: detecting changes in TV broadcasted content for a plurality of channels; communicating the detected changes to a computer storing a database of desired selective changes in viewed TV segments; and transmitting to at least one media device control signals for implementing the desired selective changes.

In a first embodiment, the detecting is automatic.

In a second embodiment, the at least one media device is selected from the group comprising: cable decoder, satellite decoder, TV set, VCR, DVD player and receiver.

In a third embodiment, the selective changes are selected from a group comprising: switching to a different channel and changing the volume.

In a fourth embodiment, the database additionally comprises information about desired action following the selective change.

In a fifth embodiment, the desired action is selected from the group comprising: switching back to the original channel, switching to a different channel and changing the volume.

According to a sixth aspect of the present invention there is provided a system for remote operation of a media device, comprising: a Web Server; a computer in communication with the Web Server, operable to receive remote operation instructions from the Web Server; a first IR/RF transceiver in communication with the computer; and a second IR/RF transceiver in communication with the first IR/RF transceiver and with at least one media device, wherein the first and second IR/RF transceivers are operable to communicate from the computer to the at least one media device control signals for implementing the instructions.

In a first embodiment, the media device is selected from the group comprising: cable decoder, satellite decoder, TV set, VCR, DVD player and receiver.

In a second embodiment, the instructions are selected from the group comprising: turning on, recording and turning off.

In a third embodiment, the system additionally comprises a cellular phone for transmitting the instructions to the Web Site.

### BRIEF DESCRIPTION OF THE DRAWINGS

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a schematic drawing showing the various parts of the system of the present invention and the interconnections therebetween;

FIG. 2 is a schematic drawing of the first IR/RF Transceiver according to a preferred embodiment of the present invention;

FIG. 3 is a schematic drawing of the second IR/RF Transceiver according to a preferred embodiment of the present invention;

FIG. 4 is a flowchart describing the operation of the server part according to a preferred embodiment of the present invention;

FIGS. 5A and 5B are coding examples of a Full Status Packet and a Mini Status Packet respectively, according to a preferred embodiment of the present invention;

FIG. 6 is a table showing the various options provided to the user of the system according to a preferred embodiment of the present invention; and

FIGS. 7A and 7B are flowcharts describing the operation of the system according to a preferred embodiment of the present invention.

### DETAILED DESCRIPTION OF PREFERRED EMBODIMENTS

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

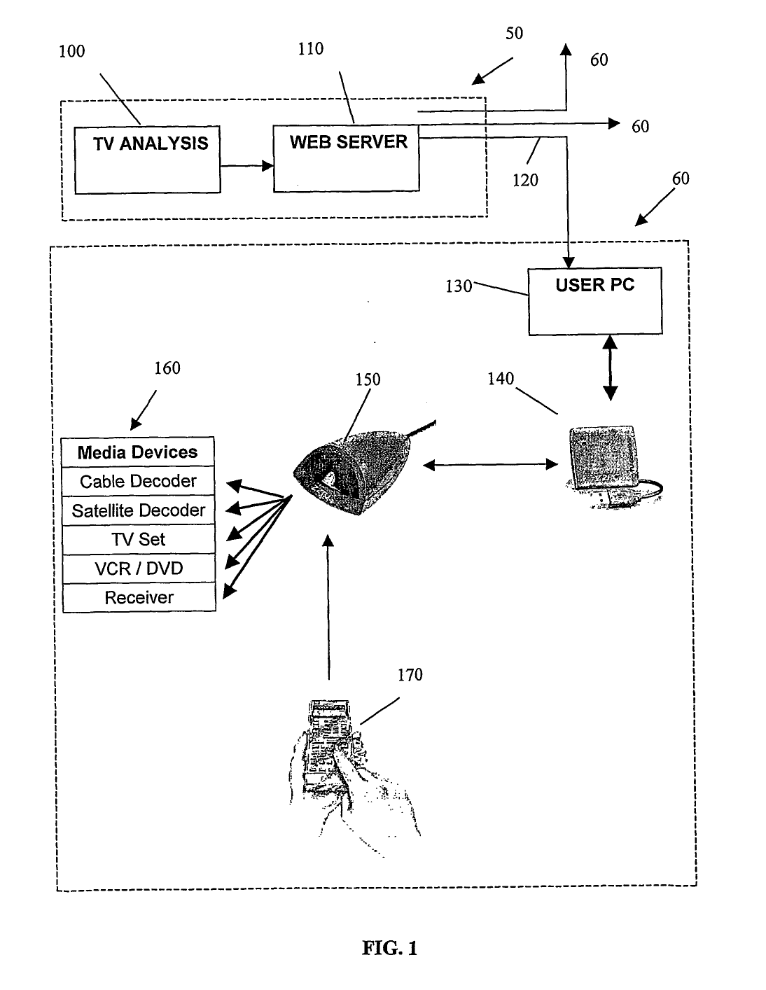

FIG. 1 is a schematic drawing showing the various parts of the system of the present invention and the interconnections therebetween.

The system is generally divided into a server part, generally denoted by numeral 50 and a client part, generally denoted by numeral 60.

Server part 50 comprises a TV Analysis function 100, whose function is to monitor changes in broadcasted segments and alert the Web Server 110 accordingly. The TV Analysis function 100 may be done either automatically, e.g. as described in U.S. Pat. No. 6,597,405, or by actual people watching the various TV channels and monitoring changes in broadcasted segments.

The Web Server 110 may be any known in the art web server, whose task in conjunction with the system of the present invention is to process and relay the information provided by the TV Analysis function 100 to various service subscribers (Clients) 60 over a communication network, preferably the Internet network 120.

Client part 60 comprises a user PC 130, such as an IBM PC connected to the Web Server 110 via Internet connection 120. PC 130 is also connected, via a USB port, to a first IR/RF Transceiver 140, whose task is to convert and transmit signals between the PC 130 and a second IR/RF Transceiver 150, as will be explained in detail hereinbelow. Second IR/RF Transceiver 150 transmits IR control signals, originated by the application program residing on the PC, to various Media Devices, generally denoted 160, as will be explained in detail hereinbelow. Second IR/RF Transceiver 150 may additionally receive IR signals from a hand-held remote control unit 170, e.g. indicating manual switch to another channel, convert them to RF signals and send the converted signals to the application program via first IR/RF Transceiver 140.

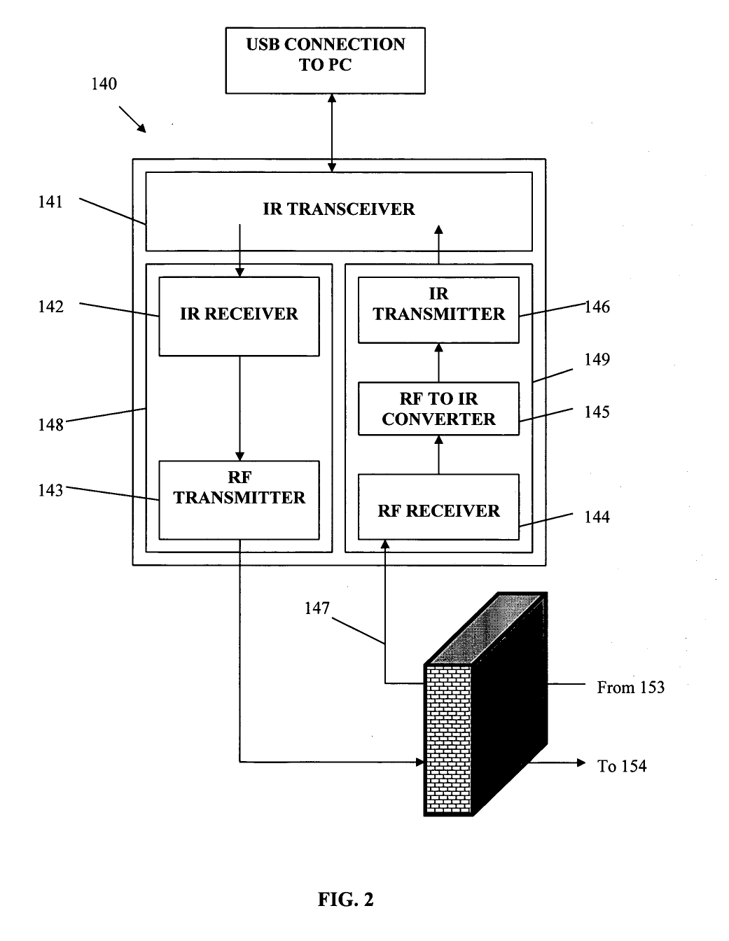

FIG. 2 is a schematic drawing of the first IR/RF Transceiver 140. The device comprises:
An IR Transceiver 141 with USB pin connectors, such as Tira2.1, available from www.home-electro.com, working at IR modulation frequency 36-40 kHz.
An IC consisting of 2 elements (148, 149):
   a. The first element 148 comprises an IR receiver module 142, such as TSOP-1138 38 kHz, available from www.vishay.com and a RF transmitter module 143, such as RF ASK TLP434A available from www.laipac.com. The output signal of IR receiver 142 feeds data to the input of the RF transmitter 143. The actual operation performed is one of converting IR to RF, since the output of the IR detector will now modulate the RF module, thereby re-creating the same signal in RF.
   b. The second element 149 comprises an RF receiver module 144, RF to IR converter 145 including custom programmed PIC (Flash 8-pin 4 MHz Microcontroller) and an IR transmitter 146, such as IR emitting diode available from www.lumex.com The RF receiver module 144 receives the incoming RF transmission 147. RF receiver 144 outputs this incoming data stream to the DIN pin of the 8-pin IC labeled RF to IR converter 145. The 8-pin IC is a custom programmed PIC12F675, available from www.rentron.com that samples the data input pin, then recreates the same data signal modulated at 38 kHz. Thus, the incoming data is converted back into a modulated IR signal.

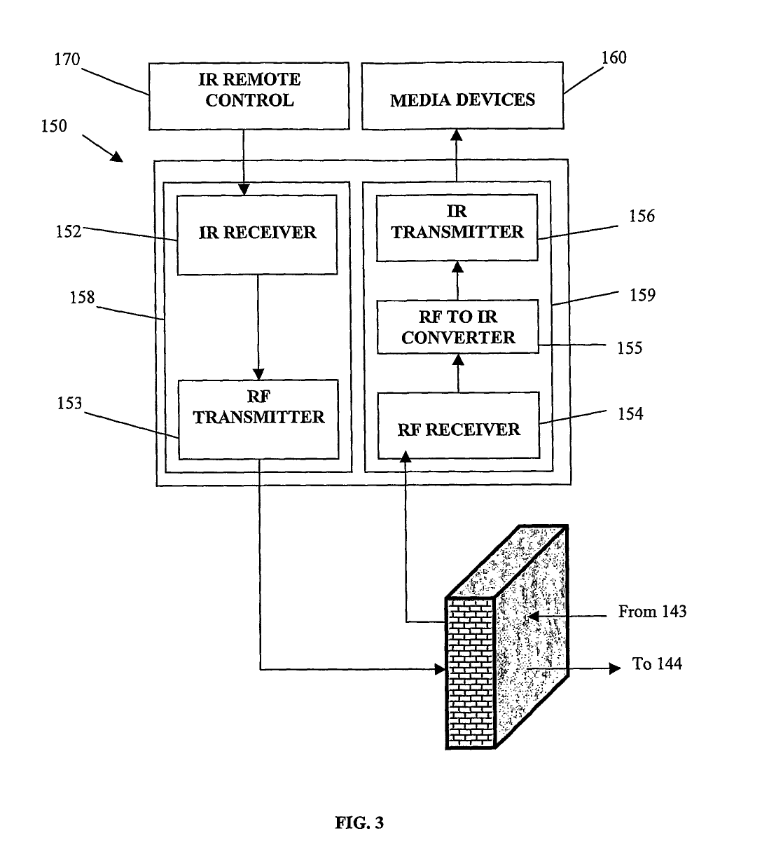

FIG. 3 is a schematic drawing of the second IR/RF Transceiver 150. The device comprises an IR transceiver and an RF transceiver on an IC, as described above in conjunction with the first IR/RF Transceiver 140. The difference between the two ICs (140, 150) lies in their operational frequencies. To avoid conflict when transmitting RF signals, it is necessary to use two different frequencies. For example, the first IC 140 may transmit RF signals on 433.92 MHz and receive RF signals on 315 MHz, while the second IC 150 transmits RF signals on 315 MHz and receives RF signals on 433.92 MHz.

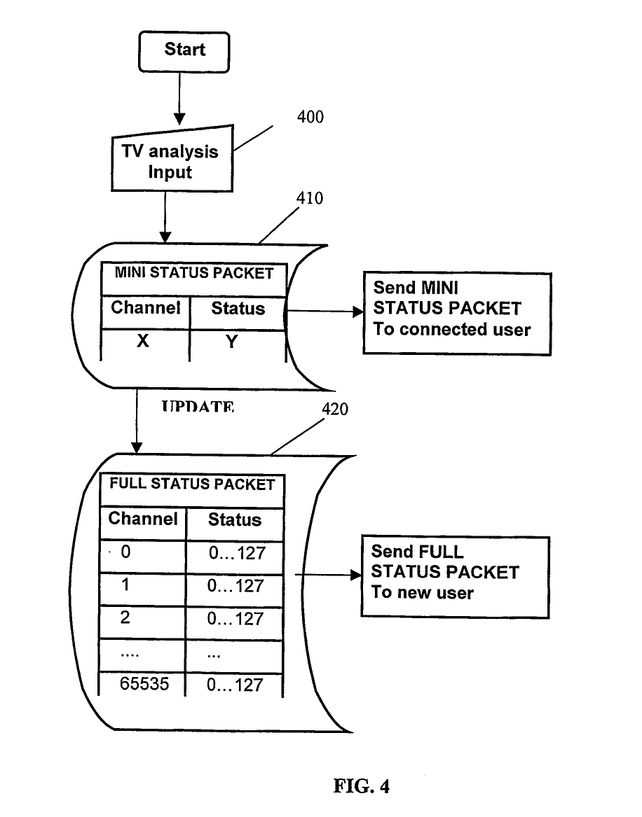

Attention is drawn now to FIG. 4, a flowchart describing the operation of the server part 50 of the system of the present invention. In step 400, the TV Analyst function 100 (FIG. 1) sends data relating to status changes in all monitored TV channels to two Status Packet creating software modules; Mini status Packet Creator 410 and Full Status Packet Creator 420. Status changes are changes in broadcasted segments per channel. For example, a status may indicate a commercial being broadcasted, or a certain program starting, or any other event as defined in the Web Server 110 application.

A Full Status Packet is a data string containing channel number and status for all monitored channels. The Full Status Packet is transmitted to a subscriber upon connecting to the service, to serve as a basis for subsequent status updates.

A Mini Status Packet is a data string containing channel number and status, only for channels where a change of status has occurred since the last update. Mini Status Packets will be transmitted as status updates to users who have already been connected to the service, and will serve to update the Full Status Packet stored in the Web Server 110.

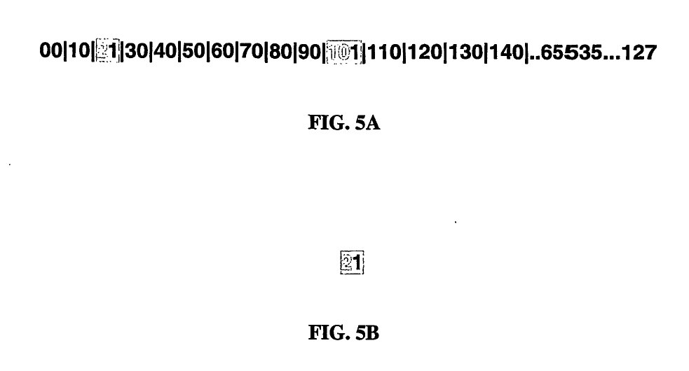

FIGS. 5A and 5B are examples of a possible physical coding scheme of Status Packets, where the channel number is encoded using 2 bytes (0 to 65535) and the status is encoded using 1 byte (0 to 127), following the channel number.

In the example of FIG. 5A, a Full Status Packet is encoded, in which channels 2 and 10 have status 1 (e.g. a commercial is now being broadcasted on both channels). The size of a Full Status Packet encoded in the coding described above is approximately 3 KB, assuming 1000 channels.

In the example of FIG. 5B, a Mini Status Packet is encoded. The size of a Mini Status Packet encoded in the coding described above is 3 bytes per changed status.

Any other suitable coding scheme may be used.

The Web Server 110 software application according to the present invention contains:
A database of all monitored TV channels and their current status.
A database of all registered users.
Updated Full Status Packet that is sent, in its entirety or as a Mini Status Packet to all currently connected users.
Optionally, broadcasting schedule of TV programs. This service is available in the market, e.g. from www.tv2day.co.il, and can be customized for the Web Server 110 of the present invention.

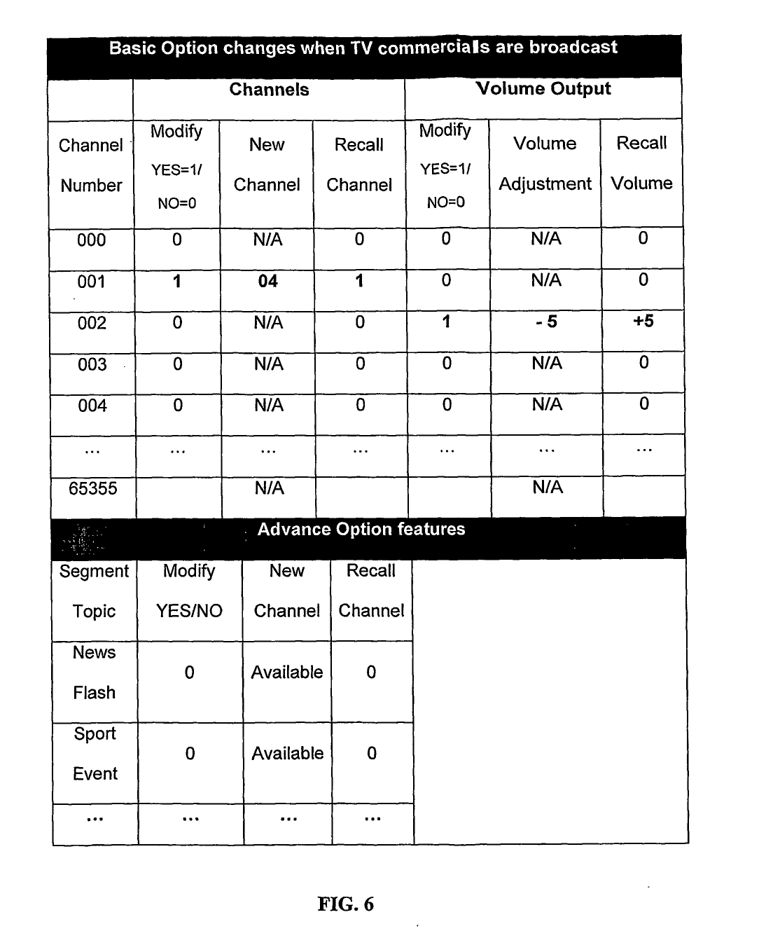

Attention is drawn now to FIG. 6, showing the various options provided to the user of the system. The user PC 130 of each subscriber to the system of the present invention runs a special User Application Software, supplied to the subscriber in any conventional manner such as by download from the Web Server 110 or on a CD. A user interface enables the user to apply the following controls to each channel in the list.

The upper part of the table of FIG. 6, as presented to the user, enables control of changes relating to commercials being broadcast. For each channel in the list, the user may:
State whether he wishes to switch to another channel when a commercial broadcast starts;
Choose which channel to switch to;
Choose which channel to return to when the commercial broadcast has ended;
   Or, alternatively:
State whether he wishes to modify the volume of his TV set when a commercial broadcast starts;
Choose the level of volume adjustment;
Choose the level of volume readjustment when the commercial broadcast has ended.

In the example of FIG. 6, the user has chosen to switch to channel 4 when a commercial is broadcasted on channel 1 and switch back to channel 1 at the end of the commercial. For channel 2, the user has elected to reduce the volume by 5 points when a commercial begins and to increase the level by 5 when the commercial broadcasting ends.

The lower part of the table of FIG. 6, as presented to the user, enables control of changes relating to segment topics other than commercials, such as a live news flash, a live sports event etc. and also to specifically named programs. For example, the user may request that any or all channels be switched to a first channel where a live sports event is starting, or even more specifically, when a predetermined event takes place, such as a goal (in football).

The changes are done in real time and executed automatically in accordance with the desired configuration and in communication with the Web Server (online status).

The Application Software may present the user with a graphical user interface, through which he may update the database residing on his PC by filling the table of FIG. 6 by way of defining the various options, such as, for example, a graphical user interface.

The Application Software requires some basic configuration parameters to be supplied by the user upon subscribing to the system, such as:
Username/Password.
User Information.
Corn Port (USB Serial Port, which is an auxiliary virtual device)
IR signals of the Cable/Satellite Decoder—for simulation of the Remote Control operation by the Second IR/RF Transceiver 150.
   The user may also supply some Advance Configuring options, such as:
Manual IR signal recording—A system tool for creating a database of IR signals of the various Media Devices 160.
Download IR signals for Media Devices from web site—IR signals database may be built/updated by downloading a manufacturer's data.
Remote configuration—User may specify a remote connection, e.g. to his cellular phone, to enable remote operation. For example, user may wish to remotely order the system to start recording a program at a specific time.

When entering the user application, the Application Software:
1. Enables the hardware (First IR/RF transceiver 140).
2. Connects to the Web Server 110 (Checking Registration).
3. Waits for synchronization (ID of currently viewed channel), either from a remote control 170, via second IR/RF transceiver 150, or manually.
4. Activate or deactivate the service from a remote control 170, via second IR/RF transceiver 150, or manually.

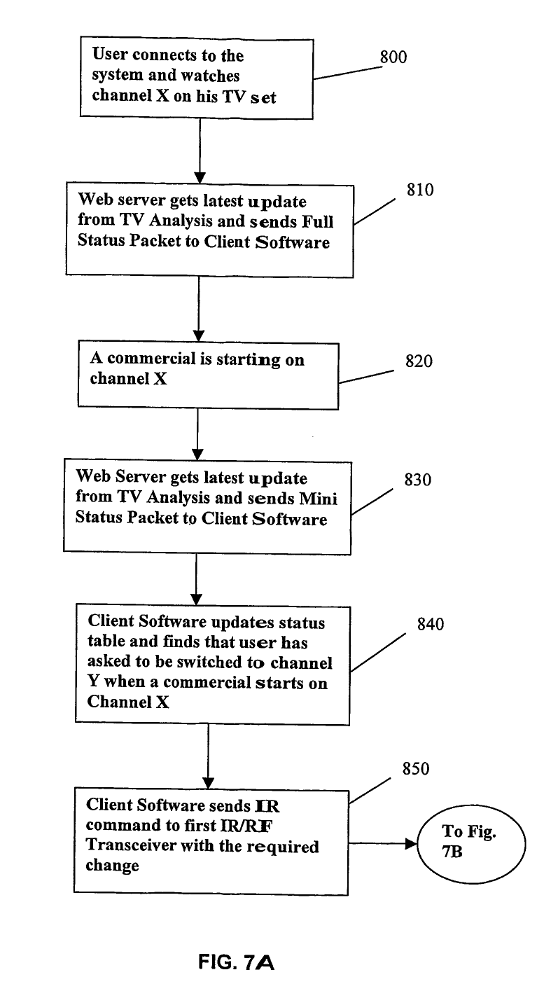

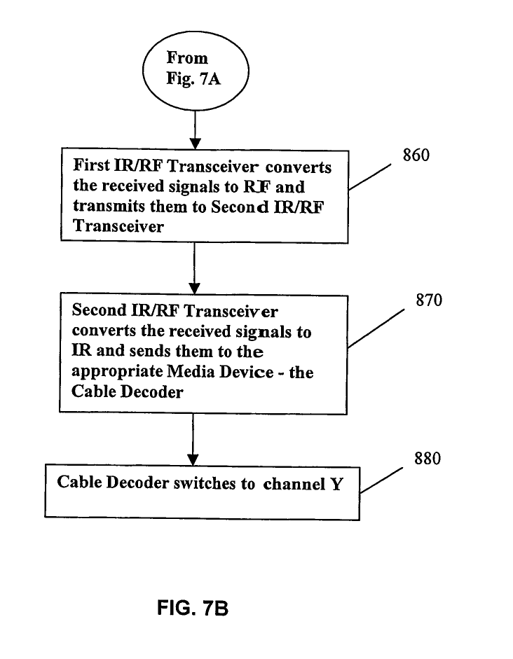

Having described the various hardware and software components of the present invention, the operation of the system will now be described, in conjunction with FIGS. 7A and 7B.

In Step 800, the user connects to the system through his Client Application and switches on his TV set to watch Channel X. A synchronization signal is sent from the Remote Control device 170 to the PC 130. The Web Server 110, having been notified that the user has connected, gets the latest status update from the TV Analysis function and sends a Full Status Packet to the User's PC, in Step 810, to initialize the session. At a certain moment, a commercial broadcast begins on channel X (Step 820). The change is reported to the Web Server and the latter sends a Mini Status Packet to the User's PC, in Step 830, indicating the changed status of Channel X. In Step 840, the Client Software gets the new report, updates its status table and finds out that the user has asked to be switched to Channel Y in the event of commercial broadcasting on Channel X. In Step 850, the switch cycle starts by the Client Software sending the appropriate command as IR signals to the first IR/RF Transceiver 140, via the PC's USB port. In step 860, the first IR/RF Transceiver 140 converts the received signals to RF signals and transmits them to the second IR/RF Transceiver 150 which, in Step 870, converts the signals back to IR signals and triggers the channel switching operation by sending the signals to the appropriate Media Device 160, in this case the Cable Decoder. In Step 880, the Cable Decoder decodes the command and switches to Channel Y.

A similar sequence of operations will take place at the end of the commercial broadcast on Channel X and the Cable Decoder will switch back to Channel X, or to whichever channel has been specified by the User.

Other Media Devices capable of being controlled by the system of the present invention are, for example, a satellite decoder, a TV set, a VCR or DVD device and a receiver.

The system of the present invention may serve as a remote control system for controlling the various Media Devices 160. For example, a user may request the web site to send a signal to his home PC, at a specific date and time, to perform operations such as:
Turn on the TV set
Turn on cable/satellite decoder and switch to a specific channel
Record a program while skipping commercials (sending Pause signals when commercials are broadcasted)
Switch off the TV set, cable/satellite decoder and VCR when program ends.
   Alternatively, the user may trigger these operations using his cellular phone Internet connection.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described hereinabove. Rather the scope of the present invention is defined by the appended claims and includes both combinations and subcombinations of the various features described hereinabove as well as variations and modifications thereof which would occur to persons skilled in the art upon reading the foregoing description.

I claim:

1. A system for reporting selective changes in TV broadcasting content, comprising:
TV analysis means for detecting and reporting changes in TV broadcasted content for a plurality of channel; and
a Web Server in communication with said TV analysis means, for receiving said reported changes and for transmitting them to at least one subscriber, said Web Server storing a database of said plurality of channels and their current status;
wherein said transmitting comprises selectively transmitting a full status report for all said plurality of channels or a partial status report for a selected number of channels.

2. The system of claim 1, wherein said TV analysis means is automatic.

3. The system of claim 1, wherein said Web Server transmits a full status report to said at least one subscriber upon said subscriber connecting to the system.

4. A system for selectively changing viewed TV segments, comprising:
TV analysis means for detecting and communicating changes in TV broadcasted content for a plurality of channels;
a computer storing a database of desired selective changes in viewed TV segments, said computer in communication with said TV analysis means;
a first IR/RF transceiver in communication with said computer; and
a second IR/RF transceiver in communication with said first IR/RF transceiver and with at least one media device,
wherein said first and second IR/RF transceivers are operable to communicate from said computer to said at least one media device control signals for implementing said desired selective changes.

5. The system of claim 4, wherein said TV analysis means is automatic.

6. The system of claim 4, wherein said at least one media device is selected from the group comprising: cable decoder, satellite decoder, TV set, VCR, DVD player and receiver.

7. The system of claim 4, wherein said selective changes are selected from a group comprising: switching to a different channel and changing the volume.

8. The system of claim 7, wherein said database additionally comprises information about desired action following said selective change.

9. The system of claim 8, wherein said desired action is selected from the group comprising: switching back to the original channel, switching to a different channel and changing the volume.

10. The system of claim 4, wherein said first IR/RF transceiver is operable to receive IR signals from said computer, convert the IR signals to RF signals and transmit the RF signals to the second IR/RF transceiver.

11. The system of claim 10, wherein said second IR/RF transceiver is operable to receive RF signals from the first IR/RF transceiver, convert them to IR signals and transmit the IR signals to said at least one media device.

12. The system of claim 4, additionally comprising a hand held remote control device, operable to transmit to said second IR/RF transceiver IR signals denoting change of viewed channel.

13. The system of claim 12, wherein said second IR/RF transceiver is operable to convert said IR signals to RF signals and transmit the RF signals to said first IR/RF transceiver.

14. The system of claim 13, wherein said first IR/RF transceiver is operable to convert said RF signals to IR signals and communicate the IR signals to said computer for synchronization.

15. A system for selectively changing viewed TV segments, comprising:
TV analysis means for detecting and reporting changes in TV broadcasted content for a plurality of channels;
a Web Server in communication with said TV analysis means, for receiving said reported changes and for transmitting them to at least one subscriber, said Web Server storing a database of said plurality of channels and their current status;
at least one subscriber computer storing a database of desired selective changes in viewed TV segments, said computer in communication with said Web Server;
a first IR/RF transceiver in communication with said computer; and
a second IR/RF transceiver in communication with said first IR/RF transceiver and with at least one media device,
wherein said first and second IR/RF transceivers are operable to communicate from said computer to said at least one media device control signals for implementing said desired selective changes.

16. The system of claim 15, wherein said TV analysis means is automatic.

17. The system of claim 15, wherein said Web Server transmits a full status report to said at least one subscriber upon said subscriber connecting to the system.

18. The system of claim 15, wherein said at least one media device is selected from the group comprising: cable decoder, satellite decoder, TV set, VCR, DVD player and receiver.

19. The system of claim 15, wherein said selective changes are selected from the group comprising: switching to a different channel and changing the volume.

20. The system of claim 19, wherein said database additionally comprises information about desired action following said selective change.

21. The system of claim 20, wherein said desired action is selected from the group comprising: switching back to the original channel, switching to a different channel and changing the volume.

22. The system of claim 15, wherein said first IR/RF transceiver is operable to receive IR signals from said computer, convert the IR signals to RF signals and transmit the RF signals to the second IR/RF transceiver.

23. The system of claim 22, wherein said second IR/RF transceiver is operable to receive RF signals from the first IR/RF transceiver, convert them to IR signals and transmit the IR signals to said at least one media device.

24. The system of claim 15, additionally comprising a hand held remote control device operable to transmit to said second IR/RF transceiver IR signals denoting change of viewed channel.

25. The system of claim 24, wherein said second IR/RF transceiver is operable to convert said IR signals to RF signals and transmit the RF signals to said first IR/RF transceiver.

26. The system of claim 25, wherein said first IR/RF transceiver is operable to convert said RF signals to IR signals and communicate the IR signals to said computer for synchronization.

27. A method of reporting selective changes in TV broadcasting content, comprising the steps of:
detecting changes in TV broadcasted content for a plurality of channels; and
reporting said detected changes to at least one subscriber;
wherein said reporting comprises selectively transmitting a full status report for all said plurality of channels or a partial status report for a selected number of channels.

28. The method of claim 27, wherein said detecting is automatic.

29. A method of selectively changing viewed TV segments, comprising the steps of:
detecting changes in TV broadcasted content for a plurality of channels;
communicating said detected changes to a computer storing a database of desired selective changes in viewed TV segments; and
transmitting to at least one media device control signals for implementing said desired selective changes.

30. The method of claim 29, wherein said detecting is automatic.

31. The method of claim 29, wherein said at least one media device is selected from the group comprising: cable decoder, satellite decoder, TV set, VCR, DVD player and receiver.

32. The method of claim 29, wherein said selective changes are selected from a group comprising: switching to a different channel and changing the volume.

33. The method of claim 32, wherein said database additionally comprises information about desired action following said selective change.

34. The method of claim 33, wherein said desired action is selected from the group comprising: switching back to the original channel, switching to a different channel and changing the volume.

35. A system for remote operation of a media device, comprising:
a Web Server;
a computer in communication with said Web Server, operable to receive remote operation instructions from the Web Server;
a first IR/RF transceiver in communication with said computer; and
a second IR/RF transceiver in communication with said first IR/RF transceiver and with at least one media device,
wherein said first and second IR/RF transceivers are operable to communicate from said computer to said at least one media device control signals for implementing said instructions.

36. The system of claim 35, wherein said media device is selected from the group comprising: cable decoder, satellite decoder, TV set, VCR, DVD player and receiver.

37. The system of claim 35, wherein said instructions are selected from the group comprising: turning on, recording and turning off.

38. The system of claim 35, additionally comprising a cellular phone for transmitting said instructions to the Web Site.
